(19) United States
(12) Patent Application Publication
(10) Pub. No.: US 2002/0186070 A1
(43) Pub. Date: Dec. 12, 2002

(54) Power stealing circuit to charge a capacitor

(75) Inventors: Bruce Carl Wall, Colorado Springs, CO (US); John William Arachtingi, Colorado Springs, CO (US)

Correspondence Address: Law Office of Dale B. Halling, LLC, Suite 311, 24 S. Weber Street, Colorado Springs, CO, 80903, US

(73) Assignee: EM (US) Design, Inc.

(21) Appl. No.: 09/876,537

(22) Filed: Jun. 7, 2001

(51) Int. Cl. H02J 1/00

(52) U.S. Cl. 327/530

(57) ABSTRACT

A power stealing circuit to charge a capacitor includes a passive electrical power channel. The passive electrical power channel has an input connected to an input signal and an output designed to be connected to the capacitor. An active electrical power channel is powered by the capacitor. The active electrical power channel has an input connected to the input signal and an output connected to the capacitor.

### FIELD OF THE INVENTION

The present invention relates generally to the field of electronics and more particularly to a power stealing circuit to charge a capacitor.

### BACKGROUND OF THE INVENTION

There are devices that plug into computer ports and require power. However, not all computer ports provide a power pin. As a result these devices have to provide their own power. Commonly this results in the device including a battery or a separate power plug. Batteries eventually run out of power and the user may not even know that the device contains a battery. As a result the user will be frustrated that his device does not work and he will not know how to fix the problem. External power cords are cumbersome and require significant additional circuitry to provide the required direct current voltage.

Another solution to this problem has been to use a diode to steal power from an information signal. Unfortunately this limits the voltage on a capacitor to a diode drop below the maximum input signal.

Thus there exists a need for circuit that can be self powered and is not limited to a diode drop below the maximum input signal.

### BRIEF DESCRIPTION OF THE DRAWINGS

FIG. 1 is a block diagram of a power stealing circuit in accordance with one embodiment of the invention;

FIG. 2 is a schematic diagram of a power stealing circuit in accordance with one embodiment of the invention; and

FIG. 3 is a schematic diagram of a power stealing circuit in accordance with one embodiment of the invention.

### DETAILED DESCRIPTION OF THE DRAWINGS

A power stealing circuit to charge a capacitor includes a passive electrical power channel. The passive electrical power channel has an input connected to an input signal and an output designed to be connected to the capacitor. An active electrical power channel is powered by the capacitor. The active electrical power channel has an input connected to the input signal and an output connected to the capacitor. In one embodiment the passive electrical power channel is a diode. In another embodiment the active electrical power channel is an operational amplifier (comparator) that drives the gate of a transistor. The passive circuit initially powers the capacitor that acts as the power supply for the active electrical power channel and a circuit requiring power. Once the capacitor has some charge the active circuit is the main path that charges the capacitor. The active circuit does not result in a diode drop in voltage and can charge the capacitor to almost the full voltage of the input signal. The capacitor also drives a circuit that performs the function desired by an end user.

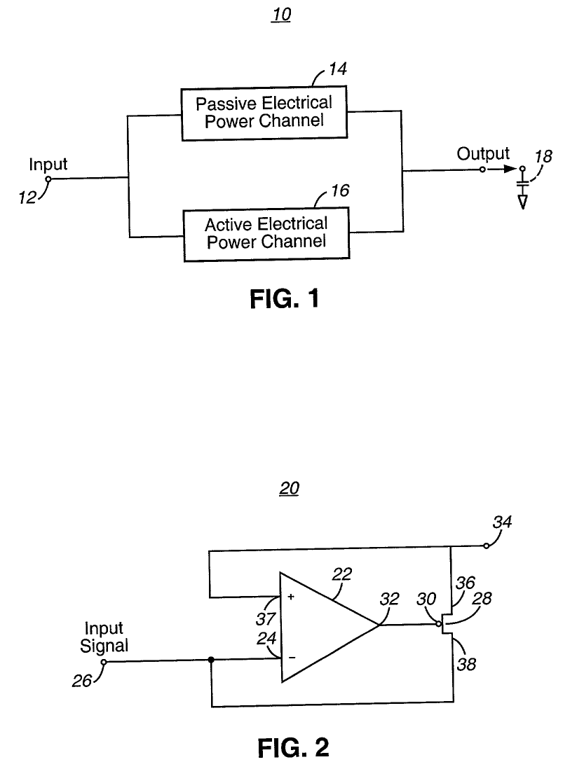

FIG. 1 is a block diagram of a power stealing circuit 10 in accordance with one embodiment of the invention. An input signal 12 is connected to a passive electrical power channel 14. The input signal 12 is also connected to an active electrical power channel 16. The output of the passive electrical power channel 14 and the active electrical power channel is connected to a capacitor 18. The capacitor 18 acts as the power supply for the active electrical power channel 16 and for a circuit that requires power.

FIG. 2 is a schematic diagram of a power stealing circuit 20 in accordance with one embodiment of the invention. An operational amplifier 22 has an inverting input 24 connected to an input signal 26. A transistor 28 has a gate 30 that is connected to an output 32 of the operational amplifier 22. An electrical connector 34 is electrically connected to a source 36 of the transistor 28 and the non-inverting input 37 of the operational amplifier 22. The drain 38 of the transistor 28 is connected to the inverting input 24 of the operational amplifier 22. In one embodiment the operational amplifier is replaced by a differential amplifier, comparator or similar device. In another embodiment, the input signal is an information signal. Note that when the voltage at the electrical connector 34 (capacitor) is greater than the input signal 26 no current flows through the transistor 28. When the voltage at the electrical connector 34 is less than the input signal 26 current is allowed to flow through the transistor 28. Using this circuit 20 the capacitor at connector 34 can be charged to almost the peak amplitude of the input signal. In one embodiment the circuit 20 is implemented on an integrated circuit. In one embodiment the integrated circuit is a complementary metal oxide integrated circuit. As a result the capacitor is commonly an external discrete component in order to hold sufficient charge to power a circuit. The external capacitor may be supplemented by an internal capacitor depending upon the power requirements of the circuit.

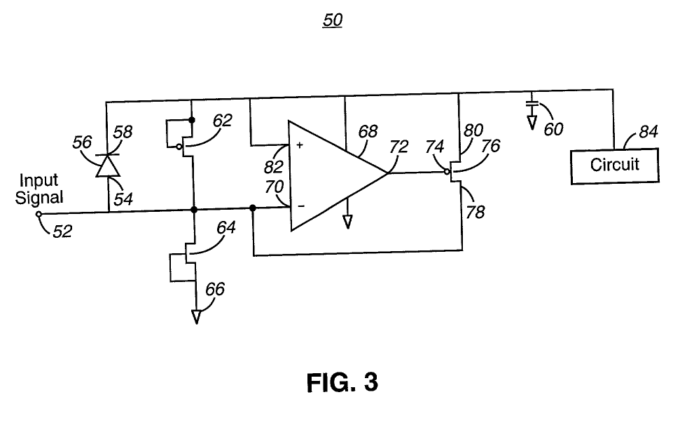

FIG. 3 is a schematic diagram of a power stealing circuit 50 in accordance with one embodiment of the invention. An input signal 52 is connected to an anode 54 of a diode 56. In one embodiment, the diode is poly-diode. The cathode 58 of the diode 56 is connected to a capacitor 60. Thus the diode 56 provides a passive electrical power channel to charge the capacitor 60. A transistor 62 is connected in parallel with the diode 56. A second transistor 64 is connected between the input signal 52 and ground 66. The transistors 62, 64 provide electrostatic discharge (ESD) protection for the circuit. An operational amplifier (comparator, differential amplifier) 68 has an inverting input (first input) 70 connected to the input signal 52. An output 72 of the operational amplifier 68 is connected to a gate 74 of a transistor 76. A drain 78 of the transistor 76 is connected to the inverting input 70. A source 80 is connected to the capacitor 60. A non-inverting input (second input) 82 is connected to the capacitor 60. The capacitor 60 powers a circuit 84 and the operational amplifier 68.

The circuit 50 provides power to the capacitor 60 through the diode 56 initially. Once the capacitor 60 has a sufficient charge the amplifier (comparator) 68 starts to work. The amplifier 68 compares the voltage of the capacitor 60 to the input signal 52. When the input signal voltage is greater than the capacitor voltage 60, the transistor 76 conducts current. As a result the input signal 52 charges the capacitor 60. When the input signal voltage is less than the capacitor voltage 60, the transistor 76 does not conduct current, which prevents the capacitor from discharging.

During initial power up conditions when there is no voltage on the capacitor 60, the ESD transistor 62 can also contribute to the charging of the capacitor. For this condition, the PMOS transistor 62 will behave like a PNP transistor (vertical PNP) where the emitter is connected to the input signal 52, the base is connected to the Cap (60) and the collector is connected to the substrate or ground. The emitter base diode junction will conduct current from the input signal to the capacitor to help charge it. However a much larger current will be conducted from the input signal (emitter) to ground (collector) which is an undesirable effect. To overcome this problem in the Passive Electrical Power Channel, the diode 56 is made to have a much larger area so it will conduct at a lower forward voltage than the PNP mode of transistor 62. This solves a key issue with using only the ESD transistor as the diode for the Passive Electrical Power Channel. The use of the poly-diode 56 (alone) limits the maximum voltage on the capacitor to a diode drop below the maximum voltage on the input signal. Note the input signal is an information signal. In one embodiment the input signal would vary between zero volts and five volts. The dynamic circuit allows the internal power supply (voltage on the capacitor) to be charged close to the maximum amplitude of the information signal. The dynamic circuit requires power to operate, which is why the passive circuit is included.

While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

What is claimed is:

1. A power stealing circuit to charge a capacitors comprising:
an operational amplifier having an inverting input connected to an input signal;
a transistor having a gate connected to an output of the operational amplifier, a drain is connected to the inverting input of the operational amplifier and a source is connected to a non-inverting input of the operational amplifier; and
an electrical connector electrically connected to the source of the transistor and designed to be connected to the capacitor.

2. The circuit of claim 1, further including a diode having an anode connected to the inverting input of the operational amplifier and a cathode connected to the non-inverting input of the operational amplifier.

3. The circuit of claim 2, wherein the operational amplifier receives power from the capacitor.

4. The circuit of claim 3, wherein the circuit is implemented on an integrated circuit.

5. The circuit of claim 4, wherein the integrated circuit is a complementary metal oxide integrated circuit.

6. The circuit of claim 3, further including an ESD connected transistor electrically connected in parallel with the diode.

7. The circuit of claim 6, further including a second transistor electrically connected from the inverting input to a ground.

8. The circuit of claim 2, wherein the diode is a poly diode.

9. A power stealing circuit to charge a capacitor, comprising:
a passive electrical power channel having an input connected to an input signal and an output designed to be connected to the capacitor; and
an active electrical power channel powered by the capacitor and having an input connected to the input signal and an output connected to the capacitor.

10. The circuit of claim 9, wherein the passive electrical power channel is a diode.

11. The circuit of claim 9, wherein the active electrical power channel includes an operational amplifier having an inverting input connected to the input signal.

12. The circuit of claim 11, wherein the input signal is an information signal.

13. The circuit of claim 11, wherein the active electrical power channel includes a transistor having a gate connected to an output of the operational amplifier, a source is connected to a non-inverting input of the operational amplifier, a drain is connected to the inverting input of the operational amplifier.

14. The circuit of claim 13, wherein the source is designed to be connected to the capacitor.

15. A power stealing circuit to charge a capacitor, comprising:
a comparator having a first input connected to an input signal;
a diode having an anode connected to the first input of the comparator and a cathode connected to a second input of the comparator; and
a transistor having a gate connected to an output of the comparator, a drain is connected to the first input of the comparator and a source is connected to the second input of the comparator.

16. The circuit of claim 15, further including an electrical connector electrically connected to the source of the transistor and designed to be connected to the capacitor.

17. The circuit of claim 15, wherein the diode is a Poly-diode.

18. The circuit of claim 15, circuit is a complementary metal oxide integrated circuit.
